(19) United States
(12) Patent Application Publication
(10) Pub. No.: US 2008/0288210 A1
(43) Pub. Date: Nov. 20, 2008

(54) APPARATUS AND METHOD FOR MONITORING DEVICE CONDITION AND COMPUTER READABLE MEDIUM

(75) Inventors: Shuichiro Imahara, Kawasaki-shi (JP); Akihiro Suyama, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 12/040,990

(22) Filed: Mar. 3, 2008

(30) Foreign Application Priority Data
May 17, 2007 (JP) 2007-131755

(51) Int. Cl. G06F 17/18; G06F 15/00

(52) U.S. Cl. 702/179; 702/182

(57) ABSTRACT

There is provided with an apparatus for monitoring condition of a device by using sensors, including: a data collecting unit configured to collect sensor data; a monitoring executing unit configured to execute monitoring logics to obtain condition values corresponding each of the monitoring logics; an output unit configured to output the values corresponding to a monitoring logic selected by selection information; a distance index calculating unit configured to calculate a distance index between a distribution of values corresponding to selected monitoring logic and each of one or more distribution of values corresponding to each of one or more other monitoring logic; and an information updating unit configured to update the selection information to select one of the other monitoring logic when a number of monitoring logics having the distribution distant more than a first threshold from that of selected monitoring logic is greater than a first threshold or equal.

### CROSS REFERENCE TO RELATED APPLICATIONS

This application is based upon and claims the benefit of priority from the prior Japanese Patent Applications No. 2007-131755, filed on May 17, 2007; the entire contents of which are incorporated herein by reference.

### BACKGROUND OF THE INVENTION

1. Field of the Invention

The present invention relates to an apparatus and a method for monitoring the condition of the device and a computer readable medium storing a program for monitoring the condition of the device.

2. Related Art

To safely and efficiently operate a device, it is necessary to keep the device in sound condition through maintenance work. Negligence of maintenance work may result in outflow of customers caused by decreased confidence in devices as a result of a rash of failures and the like, or in the worst case, may lead to a great deal of loss like the accident of the Schindler's elevator. On the other hand, since maintenance work involves high costs, it is desired to conduct regular maintenance work more efficiently and/or reduce the frequency of occasional maintenance while guaranteeing safety. As sensor data can be now easily acquired and accumulated with the development of sensing and Information Technology (IT) techniques, it is desired to monitor device condition using sensed data in support of maintenance work.

To monitor device status, it is necessary to have a mathematical logic (or model) for estimating a failure or degradation from sensor information. Creation of this logic requires sensed data, but it is practically difficult to acquire data that records every device condition for all the tens of thousands of devices in terms of communication traffic, processing speed, and/or storage capacity. This leads to a problem that degradation of performance can occur when a sensor is an unexpected one due to individual variability of a device and the like, and in particular, extreme performance degradation of a logic may occur as a result of difference and/or failure of components.

JP-A 2004-186445 (Kokai) describes that a model (or logic) for prediction and diagnosis is created from time-series data and prior models (logics) are updated so that they conform to change over time. However, the technique of JP-A 2004-186445 (Kokai) presupposes use of teaching data for evaluating a created model (or logic), and collection of teaching data is difficult and also takes much time and effort.

### SUMMARY OF THE INVENTION

According to an aspect of the present invention, there is provided with an apparatus for monitoring condition of a device by using one or more sensors observing the device, comprising:

a data collecting unit configured to collect sensor data detected by the one or more sensors;

a logic storage configured to store two or more monitoring logics for monitoring the condition of the device based on collected sensor data;

a monitoring executing unit configured to execute the monitoring logics to obtain device condition values from the monitoring logics;

an information storage configured to store selection information for selecting any one of the monitoring logics;

an output unit configured to output the device condition values corresponding to a selected monitoring logic by the selection information;

a distance index calculating unit configured to calculate a distance index between a distribution of the device condition values corresponding to the selected monitoring logic and each of one or more distribution of the device condition values corresponding to one or more other monitoring logic different from the selected monitoring logic among the monitoring logics; and

an information updating unit configured to update the selection information to select any one of the one or more other monitoring logic when a logic number of monitoring logics having the distribution distant more than a first threshold from that of the selected monitoring logic among the one or more other monitoring logic is greater than a second threshold or equal.

According to an aspect of the present invention, there is provided with a method for monitoring condition of a device by using one or more sensors observing the device, comprising:

collecting sensor data detected by the one or more sensors;

executing two or more monitoring logics each monitoring the condition of the device based on collected sensor data to obtain device condition values from the monitoring logics;

reading out selection information for selecting any one of the monitoring logics from a storage specified in advance;

outputting the device condition values corresponding to a selected monitoring logic by the selection information;

calculating a distance index between a distribution of the device condition values corresponding to the selected monitoring logic and each of one or more distribution of the device condition values corresponding to one or more other monitoring logic different from the selected monitoring logic among the monitoring logics; and

updating the selection information to select any one of the one or more other monitoring logic when a logic number of monitoring logics having the distribution distant more that a first threshold from that of the selected monitoring logic among the one or more other monitoring logic is greater than a second threshold or equal.

According to an aspect of the present invention, there is provided with a computer readable medium storing a computer program for causing a computer for monitoring condition of a device by using one or more sensors observing the device, to execute instructions to perform the steps of:

collecting sensor data detected by the one or more sensors;

executing two or more monitoring logics each monitoring the condition of the device based on collected sensor data to obtain device condition values from the monitoring logics;

reading out selection information for selecting any one of the monitoring logics from a storage specified in advance;

outputting the device condition values corresponding to a selected monitoring logic by the selection information;

calculating a distance index between a distribution of the device condition values corresponding to the selected monitoring logic and each of one or more distribution of the device condition values corresponding to one or more other monitoring logic different from the selected monitoring logic among the monitoring logics; and

updating the selection information to select any one of the one or more other monitoring logic when a logic number of monitoring logics having the distribution distant more than a first threshold from that of the selected monitoring logic among the one or more other monitoring logic is greater than a second threshold or equal.

### BRIEF DESCRIPTION OF THE DRAWINGS

FIG. 1 shows the configuration of a device control apparatus according to an embodiment of the invention;

FIG. 2 is a flowchart illustrating the flow of logic execution processing performed by the device control apparatus of FIG. 1;

FIG. 3 is a flowchart illustrating the flow of logic update processing performed by the device control apparatus of FIG. 1;

FIG. 4 is a flowchart illustrating the flow of logic evaluation processing performed by the device control apparatus of FIG. 1;

FIG. 5 shows an example of logic data;

FIG. 6 shows an example of a selection value (selection information);

FIG. 7 shows an example of a distribution distance threshold (first threshold); and

FIG. 8 shows an example of an anomaly detection threshold (second threshold).

### DETAILED DESCRIPTION OF THE INVENTION

An embodiment of the present invention will be described with reference to drawings.

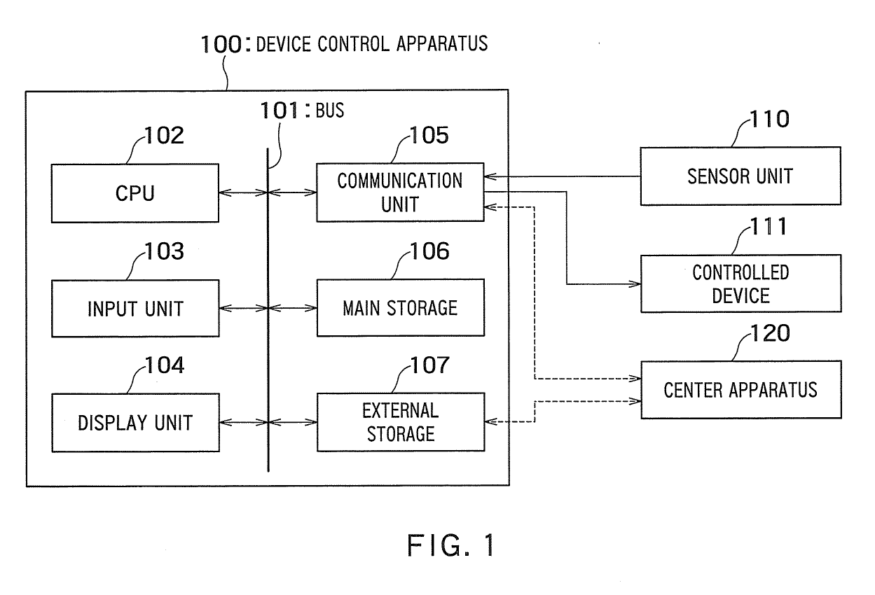

FIG. 1 shows the configuration of a device control apparatus (device condition monitoring apparatus) 100 according to an embodiment of the invention. The device control apparatus 100 includes a Central Processing Unit (CPU) 102, an input unit 103, a display unit 104, a communication unit 105, a main storage 106, and an external storage 107, the components being interconnected by a bus 101.

The CPU 102 reads a device control program stored in the external storage 107 and expands it in the main storage 106 and executes it to control the operation of components of the device control apparatus 100 and also control a controlled device 111. The CPU 102 also conducts processing that characterizes the embodiment (logic execution processing, logic updating processing, and logic evaluation processing), to be discussed later, by reading a program appropriate for the processing (a logic executing program, logic updating program, and logic evaluating program) from the external storage 107, expanding it in the main storage 106 to execute it.

The input unit 103 has an input device such as a keyboard or a mouse, and outputs operation signals generated by manipulation of the input device to the CPU 102.

The display unit 104 has a display such as a Liquid Crystal Display (LCD) or Cathode Ray Tube (CRT), and performs processing for display on a screen including results and the like produced by the execution of programs, e.g., the device control program, in accordance with display control signals input from the CPU 102.

The communication unit 105 performs communication with external devices via communication means such as Ethernet (a registered trademark), wireless LAN (Local Area Network), or Bluetooth (a registered trademark). In this embodiment, the communication unit 105 is capable of communicating with a sensor unit 110 and the controlled device 111 as external devices. The communication unit 105 may also be connected online with a center apparatus (an external device) 120 located in a management center and communicate with the apparatus.

The controlled device 111 may be a copier, elevator, and the like, for example, as a device controlled by the device control apparatus 100, being controlled in accordance with control signals input from the CPU 102 via the communication unit 105.

The sensor unit 110 has one or more sensors for observing the controlled device 111, such as a sensor for detecting the number of copies or drum temperature when the controlled device 111 is a copier or a sensor for detecting the speed or frequency of opening/closing of a door when the controlled device 111 is an elevator, for instance. The sensor unit 110 outputs sensor data obtained by the one or more sensors to the communication unit 105 of the device control apparatus 100.

The main storage 106 is composed of memory and the like, in which various programs stored in the external storage 107 (the device control, logic executing, logic updating, and logic evaluating programs) are expanded or data necessary for executing the programs and/or data resulting from execution of the programs are stored.

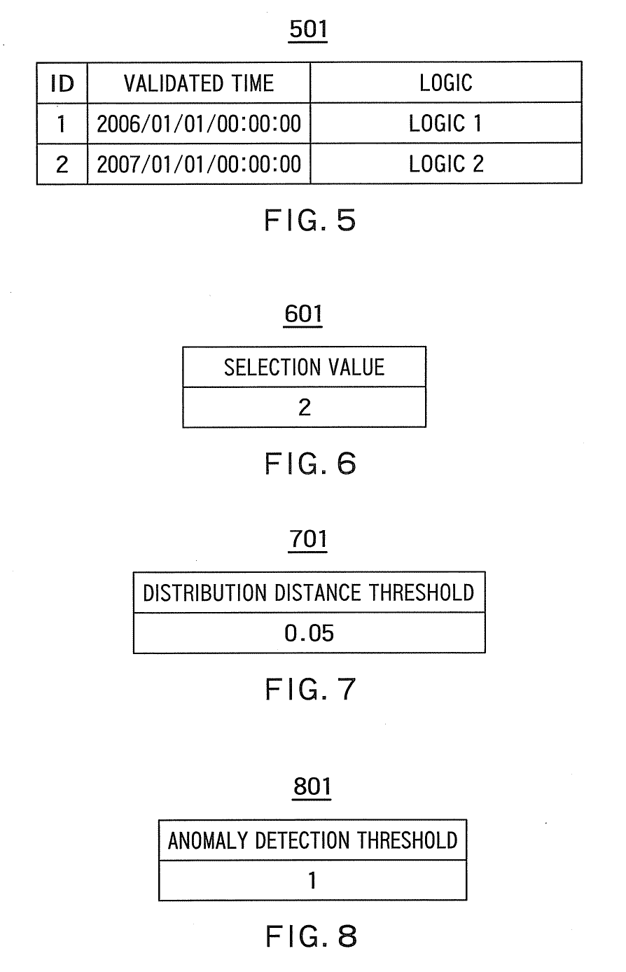

The external storage 107 is composed of a hard disk and the like, in which various programs to be executed by the CPU 102 (the device control, logic executing, logic updating, and logic evaluating programs) and/or data used at the time of executing the programs are stored. The external storage 107 has also stored therein two or more monitoring logics (or simply “logics”) for monitoring device condition based on sensor data detected by the sensor. Each of the monitoring logics exists as part of logic data discussed below (see FIG. 5). A logic storage for storing the two or more monitoring logics is included in the external storage 107.

The external storage 107 may have a reading function of reading data from a recording medium, such as a flexible disk or a CD-ROM (Compact Disc Read Only Memory). Also, some of data to be stored in the external storage 107 may be obtained from an external device via the communication unit 105. Staff of the management center may insert a recording medium containing data into the external storage 107 and have the storage 107 read in the data so as to store the data in the external storage 107.

In addition to the components described above, a printer may be provided for printing results and the like produced by execution of the programs, e.g., the device control program. Also, the configuration of the device control apparatus 100 shown in FIG. 1 may be modified as appropriate for that of the controlled device.

Various types of processing executed under the control of the CPU 102 (logic execution processing, logic update processing, and logic evaluation processing) will be described in detail below.

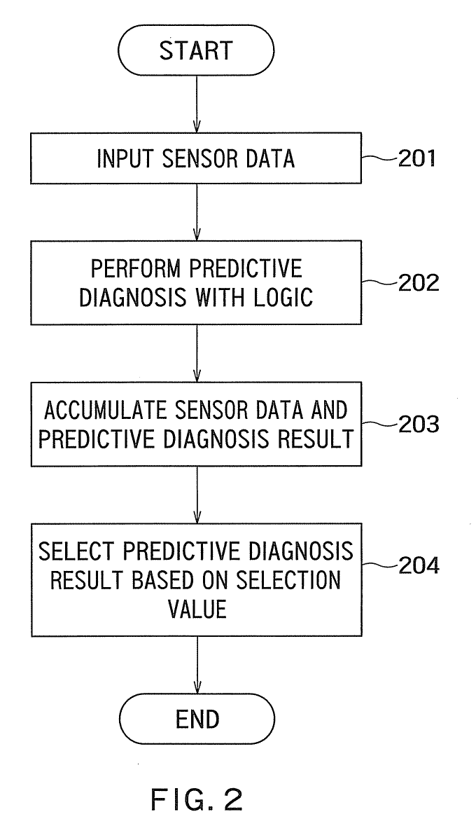

FIG. 2 is a flowchart illustrating the flow of logic execution processing which is executed under the control of the CPU 102.

In response to input of an instruction to start execution of the logic executing program from the input unit 103, or to receipt of an instruction to start execution of the logic executing program from the center apparatus 120 via the communication unit 105, the logic executing program for monitoring device condition and performing prediction and diagnosis is read from the external storage 107 and executed. Alternatively, the logic executing program may be executed by sensor data being input from the sensor unit 110 to the communication unit 105. When the logic executing program is started, logic data including the two or more logics (monitoring logics) is read from the external storage 107 into the main storage 106.

FIG. 5 shows an example of logic data 501. In the logic data 501, an ID number, a validated time, and a program operating as a logic are stored in association with each other. The ID number identifies each logic with a unique number. The validated time is written along with the logic at the time of logic update, which is discussed below, and represents a time at which the logic may be actually enabled. This mechanism can also keep a newly introduced logic which possibly has some problem not enabled for a certain time period. Although two logics are included in the logic data 501 in the example of FIG. 5, there may be three or more logics.

A sensor (sensor data) required by each logic read into the main storage 106 is retrieved at step 201, and at step 202, predictive diagnosis with each logic is performed based on the retrieved sensor. This predictive diagnosis may diagnose that the device is in normal condition or is likely to fail, or its remaining lifetime is 35 days, for example. The predictive diagnosis may also be sequentially performed at regular intervals, such as at intervals of certain seconds, minutes and the like. Such predictive diagnosis is performed with all logics stored in the logic data 501. Here, a value obtained from the predictive diagnosis (a predictive diagnosis result) represents a device condition value indicating the condition of the device. Processing at step 201 represents processing by a data collecting unit or a data collecting step for collecting sensor data. Processing at step 202 represents processing by a monitoring executing unit or a monitoring executing step for executing the two or more monitoring logics to obtain device condition values representing the condition of the device from each of the monitoring logics.

The sensor data and the predictive diagnosis result based on each logic are accumulated at step 203 in the form of values as obtained or any of various statistical values. The statistical may be of an arbitrary type, such as an average that averages predictive diagnosis results at intervals of a certain time period or a variance calculated at intervals of a certain time period.

At step 204, from among predictive diagnosis results calculated from the individual logics, the result from a logic that has the ID indicated by a monitoring logic selection value (called a selection value in the following simply) 601 is selected and output. FIG. 6 shows an example of the selection value 601. In this example, logic “2” having an ID of “2” is designated. However, if the validated time corresponding to the logic having the ID indicated by the selection value 601 is later than the present time (e.g., when a new logic whose grace period has not expired is indicated by the selection value 601), a predictive diagnosis result calculated by a logic that is the latest among ones included in the logic data 501 and whose validated time has been reached by the present time is output. The selection value 601 has been read into the main storage 106 and stored therein at the same time with the reading of the logic data 501, for example. The selection value 601 corresponds to selection information which selects one of the two or more monitoring logics, and the external storage 107 has an information storage for storing the selection value. At the step 203 mentioned above, the selection value 601 which is set at the time may also be accumulated in association with sensor data and the predictive diagnosis result based on each logic. The processing at step 204 represents processing by an output unit or an output step for outputting device condition values corresponding to a selected monitoring logic (a monitoring logic selected by the selection value).

The selection value and output at step 204 may also be transmitted to the center apparatus 120 via the communication unit 105. The predictive diagnosis result can be utilized to conduct regular maintenance more efficiently by calculating priorities among works and/or reduce the frequency of occasional maintenance by replacement before a failure.

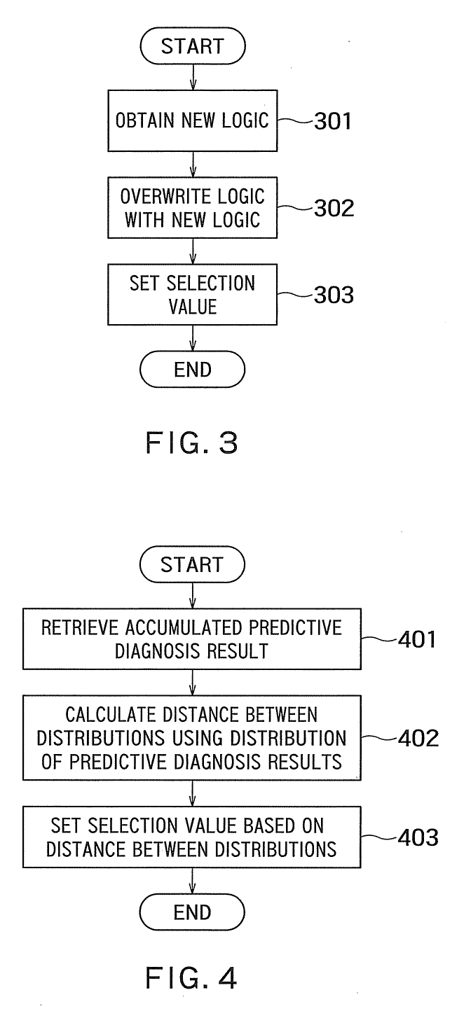

FIG. 3 is a flowchart illustrating the flow of logic update processing executed under the control of the CPU 102.

In response to input of an instruction to start the execution of the logic updating program from the input unit 103, or to receipt of an instruction to start the execution of the logic updating program from the center apparatus 120 via the communication unit 105, the logic updating program which updates logics for the purpose of performance enhancement and bug fixing is read from the external storage 107 and executed.

At step 301, a new logic and a corresponding validated time are obtained from the center apparatus 120 via the communication unit 105, or by being read from a recording medium in the external storage 107. The processing at step 301 represents processing by a data receiving unit or a data receiving step for receiving data on a new monitoring logic.

At step 302, in the logic data 501 maintained in the main storage 106, among logics other than one that has the ID indicated by the selection value 601, a logic having the oldest validated time and that validated time are overwritten with the new logic and the validated time obtained at step 301. Step 302 represents processing by a logic updating unit or a logic updating step for updating any one of monitoring logics other than the selected monitoring logic with a new monitoring logic.

Subsequently, at step 303, the selection value 601 is changed so that it indicates the ID of the new logic obtained. Processing at step 303 represents processing by a logic setting unit or a logic setting step for setting the selection value (selection information) so that the selection value (selection information) selects the updated monitoring logic. This can introduce a new logic while leaving normally functioning logics intact.

FIG. 4 is a flowchart illustrating the flow of logic evaluation processing executed under the control of the CPU 102.

In response to input of an instruction to start the execution of the logic evaluating program from the input unit 103, or to receipt of an instruction to start the execution of the logic evaluating program from the center apparatus 120 via the communication unit 105, the logic evaluating program is read from the external storage 107 and executed that determines whether the most newly introduced logic (typically a logic having the ID indicated by the selection value 601) has or possibly has degraded performance compared to the previous logic.

First at step 401, the sensor data and the predictive diagnosis result based on each logic which were accumulated at step 203 of FIG. 2 are retrieved.

At step 402, using the value retrieved at step 401, the distribution of predictive diagnosis results output by the logic having the ID indicated by the selection value 601 is compared with that of predictive diagnosis results output by other logics, and the distance index between the distributions is calculated. The distance index represents how much two distributions are approximate to each other. The step 402 represents processing performed by a distance index calculating unit or a distance index calculating step for calculating the distance index between the distribution of device condition values corresponding to the selected monitoring logic and that of device condition values corresponding to other monitoring logics than the selected one.

Examples of distance index calculation may include significance probability by Welch's t-test which statistically tests whether there is a difference between averages of predictive diagnosis results, significance probability by F-test-based homoscedasticity test which statistically tests whether there is a difference between variances of predictive diagnosis results, Kullback-Leibler sub-distance on the assumption that predictive diagnosis results are normal distributions, and an area of intersection of normal distributions on the assumption that predictive diagnosis results are normal distributions. It is also possible to classify the condition of the controlled device using the sensor data saved at step 203 and calculate a conditional probability or conditional distance.

Next, at step 403, the number of logics whose distance index calculated at step 402 does not satisfy a distribution distance threshold 701 (e.g., the number of logics whose distance index is below the distribution distance threshold 701) is calculated. The distribution distance threshold 701 corresponds to a first threshold. FIG. 7 shows an example of the distribution distance threshold 701. The distribution distance threshold 701 has been read into the main storage 106 and stored therein simultaneously with reading of the logic data 501, for example. As examples of the distribution distance threshold 701, “0.01” or “0.05” is possible as the significance level when the distance index calculation is based on significance probability by Welch's t-test or significance probability by F-test-based homoscedasticity test. In a case where the distance index calculation uses Kullback-Leibler sub-distance or the area of intersection of normal distributions, the distribution distance threshold which has been tested by preliminary experiments may be given. A logic that does not satisfy the distribution distance threshold 701 means that the distribution thereof has a large distance from the distribution for a logic that has the ID indicated by the selection value 601.

Then, at the same step 403, it is determined whether the number of logics having a distance index below the distribution distance threshold 701 is equal to or greater than an anomaly detection threshold 801. FIG. 8 shows an example of the anomaly detection threshold 801. This example shows the anomaly detection threshold 801 of “1”. The anomaly detection threshold 801 has been read into the main storage 106 and stored therein simultaneously with the reading of the logic data 501, for example. The anomaly detection threshold 801 represents a second threshold, for example.

When the number of logics below the distribution distance threshold 701 is equal to or greater than the anomaly detection threshold 801 (i.e., when the number of logics having the distribution distant largely from the logic indicated by the selection value 601 is equal to or greater than the anomaly detection threshold 801), it is assumed that the latest logic (typically the one indicated by the selection value 601) possibly has caused performance degradation as compared to the prior logic. Accordingly, the selection value 601 is set so that it indicates the ID of the second latest logic among logics included in the logic data 501, and the validated time corresponding to the latest logic (typically the one indicated by the selection value 601) is changed to a value older than the oldest validated time. That is to say, the selection value 601 normally indicates a logic that has the most recent validated time, but it indicates an older logic when the latest logic has been determined to be inappropriate due to individual variability of devices and the like. Consequently, the predictive diagnosis result from a logic that was previously being executed and has no problem is output at step 306 of FIG. 2. Also, a logic for which possible performance degradation is detected at step 403 will be preferentially overwritten at step 302 of FIG. 3.

In this example, since the selection value 601 indicates “ID2” and the anomaly detection threshold 801 is “1”, if the distribution by logic “1” does not satisfy the distribution distance threshold 701, the selection value 601 is rewritten to indicate logic “1” which is older than logic “2”, and also the validated time of logic “2” is updated to an older time than that of logic “1”.

The step 403 includes processing by an information updating unit or an information updating step for rewriting selection value (selection information) so that the selection value (selection information) selects any one of other monitoring logics when the number of other monitoring logics having a distribution distant largely from the distribution for the selected monitoring logic is equal to or greater than a second threshold.

As has been described above, according to this embodiment, when a noticeable difference is found in comparison of the distribution of predictive diagnosis results from the latest logic and that of predictive diagnosis results from the previous logic, by assuming that the latest logic is functioning in an unexpected manner and returning to the output of the previous logic, it is possible to prevent performance degradation at the time of updating to a new logic. In such a manner, device condition can be safely and simply monitored using logics.

What is claimed is:

1. An apparatus for monitoring condition of a device by using one or more sensors observing the device, comprising:
a data collecting unit configured to collect sensor data detected by the one or more sensors;
a logic storage configured to store two or more monitoring logics for monitoring the condition of the device based on collected sensor data;
a monitoring executing unit configured to execute the monitoring logics to obtain device condition values corresponding to each of the monitoring logics;
an information storage configured to store selection information for selecting any one of the monitoring logics;
an output unit configured to output the device condition values corresponding to a selected monitoring logic by the selection information;
a distance index calculating unit configured to calculate a distance index between a distribution of the device condition values corresponding to the selected monitoring logic and each of one or more distribution of the device condition values corresponding to one or more other monitoring logic different from the selected monitoring logic among the monitoring logics; and
an information updating unit configured to update the selection information to select any one of the one or more other monitoring logic when a logic number of monitoring logics having the distribution distant more than a first threshold from that of the selected monitoring logic among the one or more other monitoring logic is greater than a second threshold or equal.

2. The apparatus according to claim 1, further comprising:
a data receiving unit configured to receive data on a new monitoring logic;
a logic updating unit configured to update any one of the one or more other monitoring logic with the new monitoring logic; and
a logic setting unit configured to set the selection information so that the selection information selects updated monitoring logic.

3. The apparatus according to claim 2, wherein the information updating unit updates the selection information to select a latest monitoring logic among the one or more other monitoring logic.

4. The apparatus according to claim 2, wherein the logic updating unit updates an oldest monitoring logic among the one or more other monitoring logic.

5. The apparatus according to claim 1, wherein the distance index calculating unit calculates a significance probability by Welch's t-test as the distance index.

6. The apparatus according to claim 1, wherein the distance index calculating unit calculates a significance probability by F-test-based homoscedasticity test as the distance index.

7. The apparatus according to claim 1, wherein the distance index calculating unit calculates a Kullback-Leibler sub-distance as the distance index on an assumption that device condition values corresponding to the selected monitoring logic and the one or more other monitoring logic conform to normal distributions respectively.

8. The apparatus according to claim 1, wherein the distance index calculating unit calculates an intersection area of a normal distribution corresponding to the selected monitoring logic and a normal distribution corresponding to each of the one or more other monitoring logic as the distance index on an assumption that device condition values corresponding to the selected monitoring logic and the one or more other monitoring logic conform to normal distributions respectively.

9. A method for monitoring condition of a device by using one or more sensors observing the device, comprising:
collecting sensor data detected by the one or more sensors;
executing two or more monitoring logics each monitoring the condition of the device based on collected sensor data to obtain device condition values from the monitoring logics;
reading out selection information for selecting any one of the monitoring logics from a storage specified in advance;
outputting the device condition values corresponding to a selected monitoring logic by the selection information;
calculating a distance index between a distribution of the device condition values corresponding to the selected monitoring logic and each of one or more distribution of the device condition values corresponding to one or more other monitoring logic different from the selected monitoring logic among the monitoring logics; and
updating the selection information to select any one of the one or more other monitoring logic when a logic number of monitoring logics having the distribution distant more that a first threshold from that of the selected monitoring logic among the one or more other monitoring logic is greater than a second threshold or equal.

10. The method according to claim 9, further comprising:
receiving data on a new monitoring logic;
updating any one of the one or more other monitoring logic with the new monitoring logic; and
setting the selection information so that the selection information selects updated monitoring logic.

11. The method according to claim 10, wherein the updating the selection information includes updating the selection information to select a latest monitoring logic among the one or more other monitoring logic.

12. The method according to claim 10, wherein the updating the other monitoring logic includes updating an oldest monitoring logic among the one or more other monitoring logic.

13. The method according to claim 9, wherein the calculating a distance index includes calculating a significance probability by Welch's t-test as the distance index.

14. The method according to claim 9, wherein the distance index calculating unit calculates a significance probability by F-test-based homoscedasticity test as the distance index.

15. The method according to claim 9, wherein the calculating a distance index includes calculating a Kullback-Leibler sub-distance as the distance index on an assumption that device condition values corresponding to the selected monitoring logic and the one or more other monitoring logic conform to normal distributions respectively.

16. The method according to claim 9, wherein the calculating a distance index includes calculating an intersection area of a normal distribution corresponding to the selected monitoring logic and a normal distribution corresponding to each of the one or more other monitoring logic as the distance index on an assumption that device condition values corresponding to the selected monitoring logic and the one or more other monitoring logic conform to normal distributions respectively.

17. A computer readable medium storing a computer program for causing a computer for monitoring condition of a device by using one or more sensors observing the device, to execute instructions to perform the steps of:
collecting sensor data detected by the one or more sensors;
executing two or more monitoring logics each monitoring the condition of the device based on collected sensor data to obtain device condition values from the monitoring logics;
reading out selection information for selecting any one of the monitoring logics from a storage specified in advance;
outputting the device condition values corresponding to a selected monitoring logic by the selection information;
calculating a distance index between a distribution of the device condition values corresponding to the selected monitoring logic and each of one or more distribution of the device condition values corresponding to one or more other monitoring logic different from the selected monitoring logic among the monitoring logics; and
updating the selection information to select any one of the one or more other monitoring logic when a logic number of monitoring logics having the distribution distant more than a first threshold from that of the selected monitoring logic among the one or more other monitoring logic is greater than a second threshold or equal.
